(19) United States
(12) Patent Application Publication
(10) Pub. No.: US 2007/0169985 A1
(43) Pub. Date: Jul. 26, 2007

(54) Rack and pinion steering assembly

(75) Inventors: Jagadish Kumar Peringat, Rogersville, TN (US); Eric Roline, Morristown, TN (US); Gregory Richards, Denton, TX (US)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: TRW AUTOMOTIVE U.S. LLC

(21) Appl. No.: 11/338,217

(22) Filed: Jan. 24, 2006

(51) Int. Cl. B62D 5/06

(52) U.S. Cl. 180/427

(57) ABSTRACT

A rack and pinion assembly including a housing having a rack portion and a rack disposed therein. The rack defines a rack axis. A support member configured to limit movement of the rack in a radial direction within the rack portion is also included. The rack portion includes a tapered neck portion that increases in diameter from an inboard end to an outboard end. The invention also pertains to a rack and pinion steering assembly that includes a housing having a rack portion and a rack defining a rack axis disposed therein. The rack portion includes a first rack portion that defines a first rack portion axis and a second rack portion axis that is offset relative to the first rack portion axis. The first rack portion axis is generally coaxial to the rack axis and the second rack portion axis is offset relative to the rack axis.

### BACKGROUND OF THE INVENTION

This invention relates in general to a rack and pinion steering apparatus and in particular to an improved rack housing for the rack and pinion steering apparatus.

A typical rack and pinion power steering apparatus for use in a power-assisted vehicle steering system includes a rack operatively coupled with steerable vehicle wheels and a pinion operatively coupled with a vehicle steering wheel. Teeth on the pinion are meshed with teeth on the rack such that rotation of the pinion produces linear movement of the rack, which, in turn, causes the steerable wheels to turn laterally with respect to the vehicle. The pinion is connected with the vehicle steering wheel by an input shaft and a torsion bar.

Many power-assisted rack and pinion steering apparatuses include a valve portion that uses hydraulic power to assist the steering operation of the vehicle. A valve assembly is formed within the valve portion and includes the input shaft, the torsion bar, a valve sleeve and a pinion gear. When the rack and pinion steering apparatus is mounted in a vehicle, the input shaft is connected to a steering wheel. Rotation of the steering wheel results in rotation of the input shaft. The input shaft is fixed relative to an end of the torsion bar so that rotation of the input shaft results in rotation of the end of the torsion bar. Torsion of the torsion bar causes a valve core to move relative to a valve sleeve.

In a neutral position, hydraulic fluid flows from a source through passages in the valve sleeve. An equal amount of fluid is directed into separate passages in the valve sleeve. Since an equal amount of fluid is directed through each passage, the pressure within the system is balanced. When a steering operation is performed by turning the steering wheel, the valve core is rotated relative to the valve sleeve and the valve assembly moves out of the neutral position, or is actuated, and fluid is directed toward a rack section. A piston divides the rack section into two chambers so that depending on which way the steering wheel is rotated, fluid can flow to either a left or right chamber to facilitate movement of the rack. A higher pressure in a first chamber relative to the pressure in the second chamber results in a differential pressure that causes the piston to move. When the piston moves, the rack moves and the steerable wheels are turned.

During movement of the rack relative to the housing, interaction of teeth of the rack with teeth of the gear portion of the pinion gear rotates the pinion gear. Rotation of the pinion gear rotates the valve sleeve relative to the valve core. As a result, movement of the rack rotates the valve assembly back into the neutral position. When the valve assembly is in the neutral position, fluid is again directed from the valve sleeve passages to be returned to a reservoir.

### SUMMARY OF THE INVENTION

The invention relates to a rack and pinion steering assembly that includes a housing having a rack portion, a rack, and a support member. The rack is disposed in the rack portion and defines a rack axis. The support member is configured to limit movement of the rack in a radial direction within the rack portion. The rack portion includes a tapered neck portion. The tapered neck portion increases in diameter from an inboard end to an outboard end.

The invention also relates to a rack and pinion steering assembly that includes a housing having a rack portion, and a rack. The rack portion includes a first rack portion that defines a first rack portion axis, and includes a second rack portion axis which is offset relative to the first rack portion axis. The rack is disposed in the rack portion and defines a rack axis. The first rack portion axis is generally coaxial to the rack axis and the second rack portion axis is offset relative to the rack axis.

The invention also relates to a method for forming a rack portion of a rack and pinion steering assembly. The steps of the method include providing a first core member, providing a second core member, providing an outer mold member defining a casting cavity, positioning a portion of the first core member into the casting cavity along a rack axis, positioning a portion of the second core member into the casting cavity in abutting arrangement with the first core member along the rack axis, introducing a mold material into the casting cavity, retracting the first core member from the casting cavity along the rack axis, and retracting the second core member from the casting cavity along a second axis wherein the second axis is not parallel to the rack axis.

Other advantages of this invention will become apparent to those skilled in the art from the following detailed description of the invention, when read in light of the accompanying drawings.

### BRIEF DESCRIPTION OF THE DRAWINGS

FIG. 1 is a cross-sectional view of a prior art portion of a rack and pinion steering apparatus.

FIG. 2 is an enlarged view of a portion of the rack and pinion steering apparatus of FIG. 1.

FIG. 3 is a cross-sectional view of a rack and pinion steering apparatus having a tapered profile rack housing according to the present invention.

FIG. 4 is an end view of a portion of a rack housing of the rack and pinion steering apparatus of FIG. 3.

FIG. 5 is a schematic internal view of the rack and pinion steering apparatus shown in FIG. 4 through Line 5-5.

FIG. 6 is a front elevation view of the housing used in the rack and pinion steering apparatus according to the invention.

FIG. 7 is a schematic internal view of the housing used in the rack and pinion steering apparatus according to the invention shown in FIG. 6 through Line 7-7.

FIG. 8 is a cross-sectional view of a rack and pinion steering apparatus according to a first alternate embodiment of the present invention.

FIG. 9 is a cross-sectional view of a rack and pinion steering apparatus according to a second alternate embodiment of the present invention.

FIG. 9A is a cross-sectional view of a portion of the rack and pinion steering apparatus shown in FIG. 9, showing an alternate mounting of the support ring.

FIG. 9B is a cross-sectional view of a portion of the rack and pinion steering apparatus shown in FIG. 9, showing an alternate construction of the floating seal.

FIG. 10 is a cross-sectional view of a rack and pinion steering apparatus according to a third alternate embodiment of the present invention.

FIG. 11 is a cross-sectional view of a rack and pinion steering apparatus according to a fourth alternate embodiment of the present invention.

FIG. 12 is a cross-sectional view of a rack and pinion steering apparatus according to a fifth alternate embodiment of the present invention.

### DETAILED DESCRIPTION OF THE INVENTION

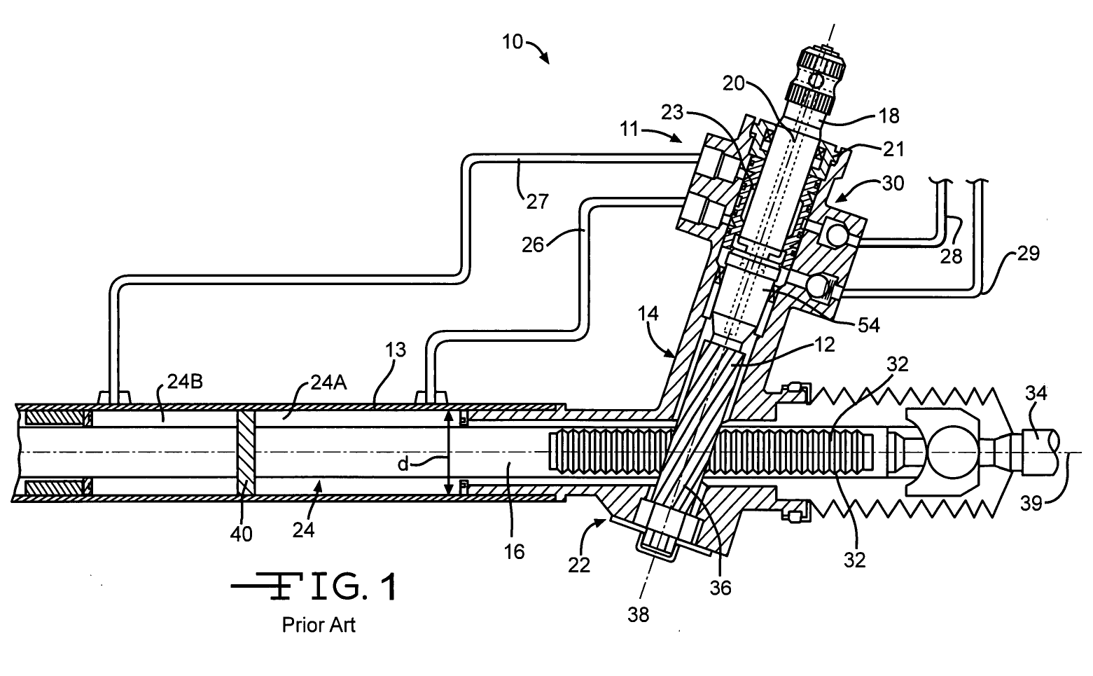

Referring now to the drawings, there is illustrated in prior art FIG. 1 a portion of a hydraulically assisted rack and pinion steering apparatus 10 having a valve assembly 11. The steering apparatus 10 further includes a pinion 12, a housing 14, a rack 16, an input shaft 18, and a torsion bar 20. It can be appreciated that the steering apparatus 10 described below could be used in either a hydraulically assisted power steering apparatus or an electronically controlled power steering apparatus.

The housing 14 has a hydraulic valve section 30 and a rack portion 22. A rack tube 13 is connected to the rack portion 22. The rack 16 is positioned within the rack tube 13 and extends through the rack portion 22 of the housing 14. The rack portion 22 is preferably integrally formed as a part of the housing 14. The rack tube 13 can be formed integrally with or separately from the rack portion 22. As shown, the rack tube 13 is formed as a separate generally tubular member that is attached to the housing 14. The rack tube 13 is typically attached to the housing 14 by press fitting the components together. A rack chamber 24 is defined by the rack tube 13. Hydraulic conduits 26 and 27 provide fluid communication between the rack chamber 24 and the valve section 30 of the housing 14. Hydraulic conduits 28 and 29 provide fluid communication between the valve section 30, a power steering pump (not shown) and a reservoir (not shown).

A piston 40 is connected to the rack 16 and is disposed in the rack chamber 24. The piston separates the rack tube 13 into a first chamber 24A and a second chamber 24B. Fluid from the valve section 30 can selectively be supplied to the first chamber 24A or second chamber 24B depending on the steering maneuver being performed. The rack 16 includes a section having rack teeth 32. The rack teeth 32 are meshed with helical teeth 36 on the pinion 12 inside the housing 14. Opposite ends of the rack 16 are connected with steerable vehicle wheels (not shown) by pivotable tie rods, one of which is shown at 34, as is known in the art. When a steering maneuver is being performed, the pinion 12 rotates about the axis 38, and the rack 16 moves longitudinally along a horizontal axis 39.

The rack and pinion steering apparatus 10 also includes a rack yoke assembly such as those shown in U.S. Pat. Nos. 5,622,085 and 5,906,138, the disclosures of which are incorporated herein by reference in their entireties. Both patents show examples of yoke assemblies disposed in a housing to support and guide the movement of a rack bar relative to a housing.

The valve assembly 11 includes the pinion 12, the input shaft 18, the torsion bar 20, and a valve sleeve 21. The valve section 30 communicates with the first chamber 24A through a first two-way hydraulic conduit 26. The valve section 30 communicates with the second chamber 24B through a second two-way hydraulic conduit 27. The valve section 30 receives hydraulic fluid from a reservoir and a pump through an inlet hydraulic conduit 28. The pump could be a flow-varying pump, and could be driven by an electric motor or by the vehicle engine. An outlet hydraulic conduit 29 exhausts hydraulic fluid from the valve section 30 to the reservoir.

The valve section 30 operates in response to rotation of the input shaft 18 with the vehicle steering wheel. When the input shaft 18 rotates with the steering wheel in a first direction about the pinion axis 38, the input shaft 18 twists slightly relative to the pinion 12. The torsion bar 20 flexes to permit such rotation of the input shaft 18 relative to the pinion 12. The valve section 30 responds to the resulting rotational displacement by opening hydraulic fluid flow paths that extend through the valve section 30 from the inlet conduit 28 to the second two-way flow conduit 27. The valve section 30 simultaneously closes the hydraulic fluid flow paths that extend through the valve section 30 from the inlet hydraulic conduit 28 to the first two-way flow conduit 26 to the outlet conduit 29. A resulting flow of hydraulic fluid from the pump, and a resulting hydraulic fluid pressure differential acting across the piston 40, due to a higher pressure in the second chamber 24B relative to the first chamber 24A, assists the movement of the piston 40 and the rack 16 to the right along the axis 39, as viewed in FIG. 1. This causes the steering linkage to steer the vehicle wheels in a first direction. With the torsion bar 20 in a neutral position, the valve section 30 is in a “normally open” position. That is, there is a fluid flow from conduit 28, through the valve sleeve 21 and out of conduit 29. The fluid pressure will be balanced within the rack chamber 24 as will the fluid pressure within conduits 26 and 27. Therefore, when the steering wheel is turned, the valve section 30 becomes further opened, thereby allowing fluid to flow through one of the conduits 26, 27 to the rack chamber 24.

As the rack 16 moves along the axis 39 with the piston 40, the pinion 12 rotates in meshing engagement with the rack teeth 32. The pinion 12 then rotates about the axis 38 relative to the input shaft 18 in a follow-up manner so as to cancel the rotational displacement between the pinion 12 and the input shaft 18. The valve section 30 responds by returning the previously opened hydraulic fluid flow paths (conduit 28 to conduit 27) to a closed position and returns the valve section 30 to its neutral position. This equalizes the hydraulic fluid pressures acting on the piston 40 in the two rack chambers, and causes the piston and the rack 16 to stop moving along the axis 39.

When the vehicle wheels are to be steered in an opposite direction, the input shaft 18 is rotated by the steering wheel in an opposite direction about the axis 38, and is again rotated slightly relative to the pinion 12 upon the flexing of the torsion bar 20. The valve section 30 responds by pressurizing the first rack chamber 24A and by simultaneously exhausting the second rack chamber 24B. The piston and the rack 16 then move axially to the left, as viewed in FIG. 1. A resulting follow-up rotation of the pinion 12 relative to the input shaft 18 causes the valve section 30 again to equalize the hydraulic fluid pressures in the two rack chambers 24A and 24B.

It can be appreciated that the form, function and operation of a rack and pinion steering apparatus such as described above is generally known in the art. It should also be appreciated that a rack and pinion steering apparatus similar to the one described above can be modified as will be described below with respect to the present invention. However, the basic operation of the present invention can be substantially similar to that which was described above.

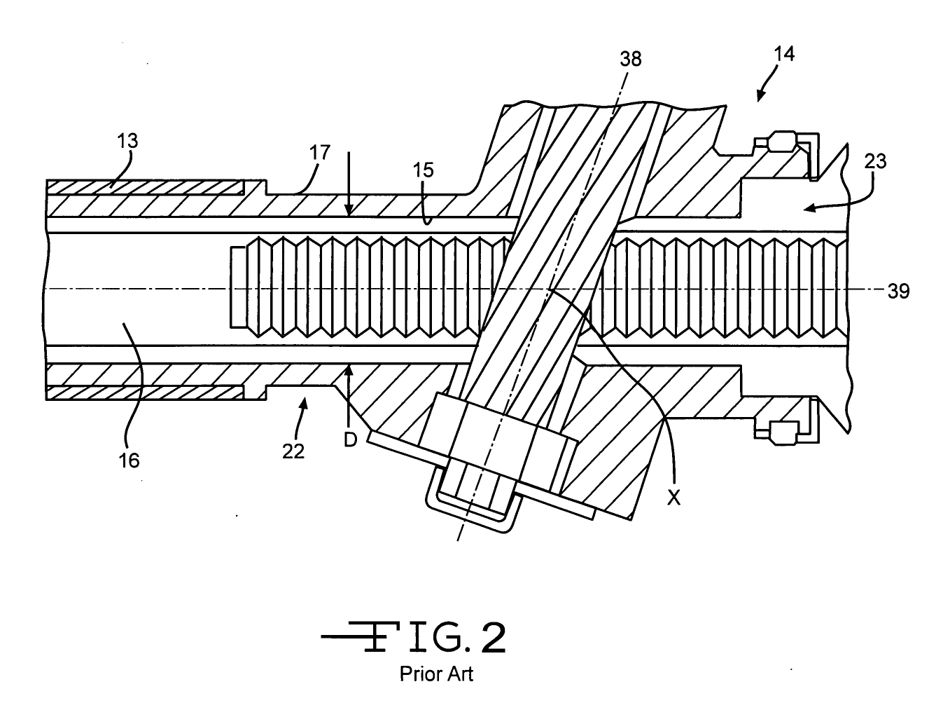

Illustrated in prior art FIG. 2 is an enlarged view of an inboard portion of the rack and pinion steering apparatus 10 of FIG. 1. In particular, the portion of the apparatus shown is near the intersection X, of the pinion 12 and the teeth 32 of the rack 16. Also shown is a portion of the rack tube 13. As shown, the rack portion 22 of the housing 14 that engages the rack tube 13 has a substantially constant inner diameter, D, such that the rack 16 can rotate about the axis 39 without interference from the rack tube 13 and the rack portion 22 of the housing 14. In the prior art, it is known to machine the inner diameter, D, of the rack portion 22 to create a substantially smooth inner surface 15 so that the surface 15 does not have burrs or other protrusions that might interfere with the operation of the rack 16. Such machining is typically required due to the process of forming the rack portion 22 and the other components of the rack and pinion steering housing 14 components. Additionally, a close tolerance is required so that the rack 16 and pinion 12 are maintained in proper contact even if the rack yoke (not shown) were to come out of engagement with the rack 16 (ratcheting). Also, as is known, during the operation of the vehicle, the rack 16 can flex within the rack tube 13 due to varying road conditions. By machining the rack portion 22 of the housing 22 to a proper tolerance, the amount of such flexing would be limited. It should be appreciated that the inner diameter, d, if the rack tube 13 may also be machined if it is so desired.

As is known in the art, the rack tube 13 is a steel tube that can be produced by induction welding a steel sheet followed by a drawing or seamless welding process to form the tube. The housing 14 is preferably formed using aluminum or other castable alloys through a casting process. The casting process can be any suitable casting process. However, typically, the casting process includes providing a substantially cylindrical core member or members (not shown) having a substantially constant outer diameter. Although the core member is described as having a substantially constant outer diameter, it should be appreciated that in order to withdraw or retract the core member from the formed cavity, the core member can have a slight draft so that it can be withdrawn. Typically, the draft angle on the core member is within the range of about 0.5 to about 5 degrees per side, and usually within the range of about 0.5 to about 2 degrees per side. It can be appreciated that the core member can also be formed having a frustoconical shape, be substantially cylindrical, or have any other configuration depending on the desired surface profile of the rack tube. For example, a core member can have a stepped portion separating a smaller outer diameter portion of the cylinder from a larger outer diameter portion of the cylinder. For example, as seen in prior art FIG. 2, the rack portion 22 of the housing 14 has a stepped portion 23.

To form the rack portion 22, the core member is positioned inside of a mold cavity. The mold cavity is further defined by an outer member having a shape that generally conforms to the desired shape of the outer surface 17 of the rack portion 22. Once the mold cavity is defined by the core member(s) and the outer member, material (e.g. steel, aluminum) is provided to fill the cavity. Once the casting process is completed, the core member is then removed, and the cast member is removed from the cavity. The core member is conventionally formed as a two-piece core wherein the two core members are positioned within the cavity from opposite ends so that the core members meet generally in the middle of the cavity. The core members are pulled out along the axis of the cavity (which is substantially the same as the rack axis 39) to form a substantially constant diameter cylindrical bore. It should be appreciated that the term “substantially constant diameter” includes the draft angle described above. Once the casting process is completed, the inner surface of the rack portion 22 is machined prior to the assembly of the rack and pinion steering apparatus. Since in the embodiment shown in FIGS. 1-2, the inner diameter of the rack portion 22 is substantially constant, a one-piece core member could be used to form the rack portion 22 during the casting process. The structure and operation of the prior art rack and pinion steering apparatus 10 thus far described is conventional in the art.

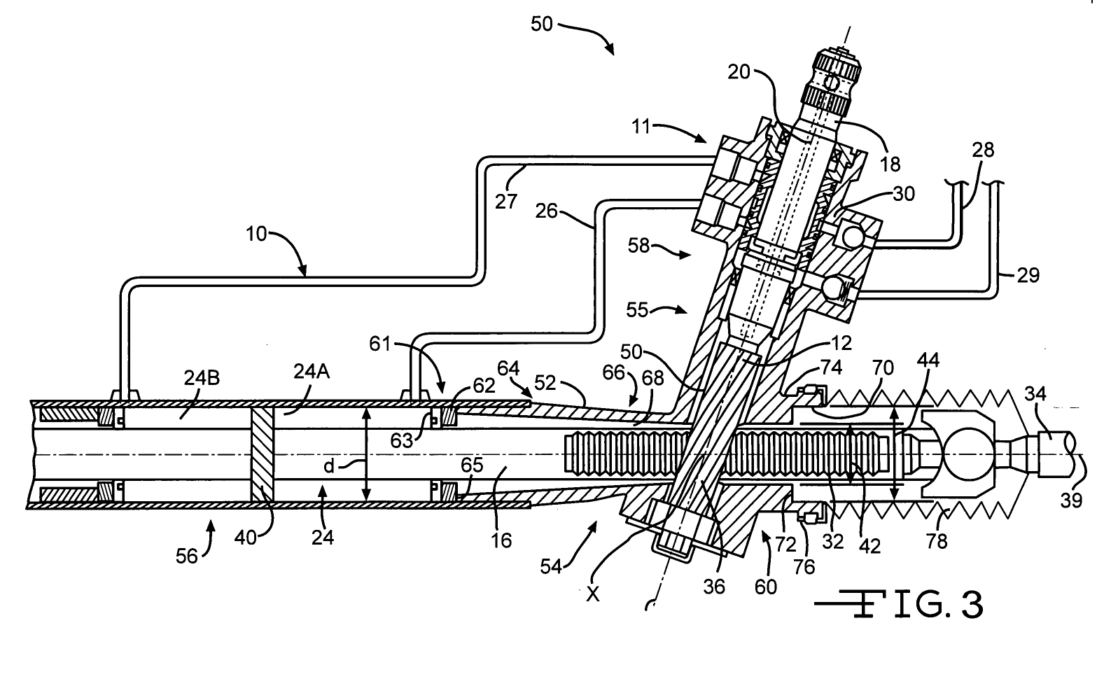

Illustrated in FIG. 3 is a rack and pinion steering apparatus, indicated generally at 50, according to the present invention with like parts having like reference numerals with respect to the rack and pinion steering assembly 10 shown in FIGS. 1 and 2. A rack portion 52 of a housing 55, is formed utilizing the method according to the present invention. The housing 55 is generally the same as the housing 14 described above, with the differences being described below. In FIG. 3, the rack portion 52 is attached to a cylinder defining a rack tube 56, the rack tube 56 being substantially similar to the rack tube 13 shown and described above with respect to FIGS. 1 and 2, with the differences being described below. Positioned within the rack chamber 24 is a piston 40. Part of the rack portion 52 is used to connect the rack portion 52 to the rack tube 56. As described above, the rack portion 52 can be attached to the rack tube 56 by press fitting the components together or using threaded fasteners. However, it should be appreciated that any suitable method can be used to connect the rack tube 56 to the rack portion 56 such as, but not limited to, conventional welding, magnetic pulse welding, shrink fitting, crimping, pinning or press fitting.

The rack portion 52 includes a tapered neck portion 54. The neck portion 54 is tapered and is, therefore, oriented at an angle relative to the rack 16 with the neck portion 54 having a larger outer diameter at the rack tube end 64 (the outboard, or left, end of the tapered neck portion as viewing FIG. 3) and tapering to a smaller outer diameter at a pinion end 66 (the inboard, or right, end of the tapered neck portion 54 as viewing FIG. 3). The pinion end 66 of the neck portion 54 is the portion closer to where the rack 16 and the pinion 12 are engaged with each other, generally at the intersection point, X. However, in the preferred embodiment, the tapered neck portion 54 is substantially concentric with the rack axis 39.

Formed integrally with the neck portion 54 is a valve housing portion 58. The valve housing portion 58 is substantially similar to that which was described above for retaining the valve assembly 11. The rack portion 52 also includes a known rack yoke assembly, including a rack yoke bearing, yoke spring, a rack housing, and a closure cap, commonly referred to as a yoke plug (as was described above with respect to U.S. Pat. Nos. 5,622,085 and 5,906,138). The rack yoke assembly is located at a position that is adjacent to the rack 16 where the rack 16 and pinion 12 are in engagement, generally indicated by the intersection, X. The right side of the rack portion 52 includes a stepped flange portion 60 on its outer surface 74 that provides an attachment surface for a protective boot 78 that fits over the rack 16. A cavity 68 is formed within the rack portion 52, the cavity 68 being configured to receive a portion of the rack 16 therein. Preferably, the rack 16 passes through the cavity 68 of the rack portion 52. The rack 16 is also preferably aligned along the rack axis 39.

A first seal mechanism 61 is included where the rack tube 56 and the neck portion 54 engage each other. The first seal mechanism 61 includes a circular rubber ring 63 (like an O-ring) with a spring member positioned therein that encircles the rack 16. The seal mechanism 61 is configured to prevent fluid from the rack chamber 24 from passing beyond the limits of the first rack chamber 24A.

A support member 62 is also included in the rack chamber 24 as a part of the first seal mechanism 61 adjacent the rubber ring 63. The support member 62 is a substantially annular member that fits within the cylindrical portion of the rack tube 56 and substantially encircles the rack 16. The support member 62 (also known as a back-up ring) can be made of a plastic, a polymer or a metal alloy. In the preferred embodiment, the support member 62 is positioned adjacent an outer face 65 of the rack tube end 64 of the neck portion 54. The support member 62 is configured to maintain the position of the rack 16 in a position that is substantially coaxial to the rack axis 39, and thus limit the amount the rack 16 might deflect in that area around the support member 62. The use of a support member 62 with the rack and pinion steering assembly 50 shown in FIG. 3 is preferred due to the shape of the neck portion 54. Many conventional rack tubes and rack portions (such as shown in FIG. 1) have a generally constant inner diameter and, therefore, the rack is prevented from deflection by the rack tube. Due to the increasing inner diameter of at least a portion of the rack housing 52 in the neck portion 54, the close tolerances of the inner surface of the rack tube 13 as shown in FIG. 1 are not present. Therefore, the support member 62 provides additional support to prevent the rack 16 from being deflected too far off the rack axis 39 and also acts as a back-up to the seal mechanism 61. However, in the area where the neck portion 54 has a larger diameter than that of the rack portion 22, the rack 16 can deflect more. Thus, the rack 16 can deflect more due to transmitted loads from the vehicle tires. The more the rack 16 deflects, the more load can be carried by the rack 16 (steel) than would be transferred through the rack portion 52 (aluminum). Thus, the rack portion 52 can be made to be more lightweight thereby reducing overall vehicle weight, and thus, vehicle efficiency.

The rack tube 56 and the rack portion 52 can be formed integrally or separately. One benefit of forming the rack tube 56 and the rack portion 52 separately is that any machining that is desired to be done to an inner surface of the neck portion 54 of the rack portion 52, or the rack tube 56 is simplified due to the ease of access into the inside of the rack portion 52. In the preferred embodiment, the neck portion 54 of the rack housing 52, the valve housing portion 58, and the stepped flange portion 60 are formed integrally. The neck portion 54 of the rack portion 52 can be formed using a first core member 121 (shown in FIG. 3) in a casting process similar to that which was described above. The first core member 121 has a tapered body to form the tapered neck portion 54 with the core member 121 tapering out to an outer diameter that is approximately the same as, or slightly larger than, the inner diameter, d of the rack tube 56. This portion of the casting process can be performed using known casting methods.

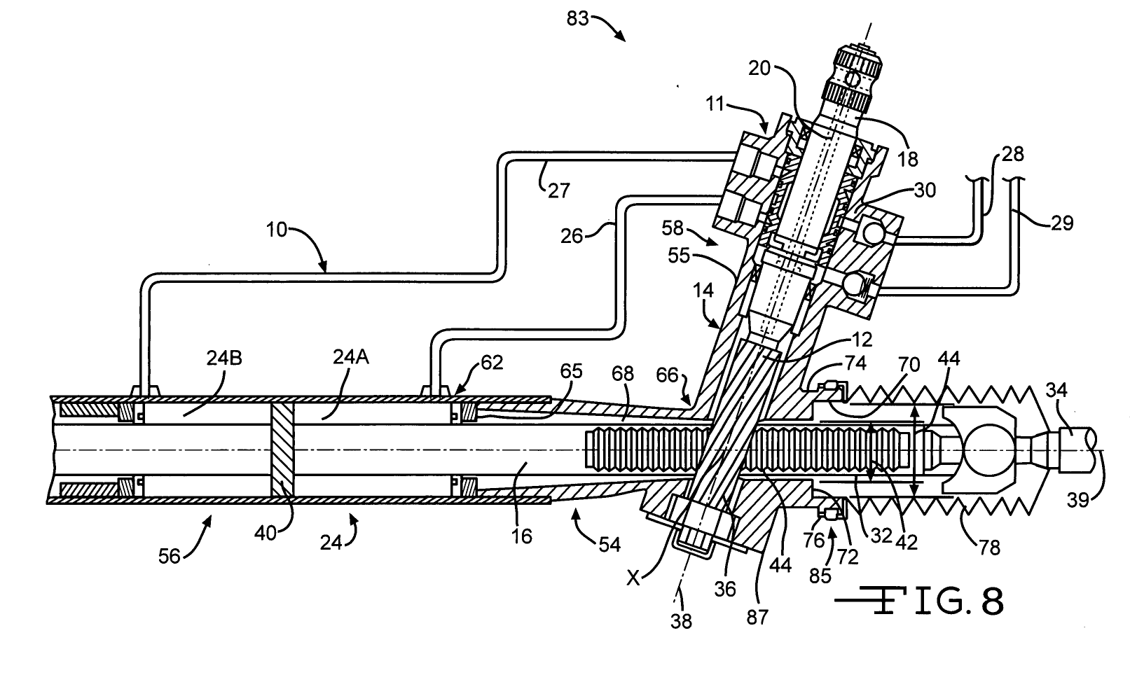

To form the stepped flange portion 60, the right side as viewing FIG. 3, of the rack portion 52, a second core member 122 (also shown in FIG. 3) would be inserted into a mold cavity from the right and be positioned against the first core member 121 at approximately the center of the rack portion 52 (where the rack and pinion engage each other, at intersection X). The second core member 122 preferably includes a stepped portion 123 such that an inner surface 70 of the rack portion 52 has a step 72 formed thereon. The second core member 122 can define a first cylinder 42 and second cylinder 44. The first cylinder is preferably coaxial with the rack axis 39 and the rack cavity 68. The second cylinder has a larger diameter than the rack cavity 68 and preferably has a center line 43 that is offset from the rack axis 39. The purpose of having the two non-coaxial cylinders is described below with respect to the angled core removal process. Although the two cylinders appear to be concentric in FIG. 3, the view of the rack portion in FIG. 7 shows the offset relationship of the two cylinders 42 and 44.

The outer surface 74 of the rack portion 52 in the stepped region forms a surface 76 upon which a boot 78 can be press fit, crimped, or clamped to support the boot 78 therewith. The boot 78 is an elastomeric boot to protect the rack 16 from the elements. Such a boot 78 is generally known in the art. As can be more clearly seen in FIGS. 4 and 7, a portion of the rack cavity 68 is formed along an axis that is not aligned with the rack axis 39. When the second core member 122 is removed from the mold cavity, the second core member 122 is withdrawn or retracted at an angle relative to the rack axis 39. The use of the core members 121, 122 in casting the rack portion 52 creates the cavity 68 within the rack portion 52. The cavity 68 is preferably sized to accommodate at least the rack 16 therein. The core members 121, 122 are preferably aligned along the rack axis 39 when the casting process is started. When the second core member 122 is removed, the second core member 122 is withdrawn along an axis 86 (shown in FIG. 7) that is at an angle, and therefore not parallel, to the rack axis 39. In a preferred embodiment, the angle of withdrawal of the second core member 122 is approximately 1 to 2 degrees. However, the angle of withdrawal is preferably such that one edge 82 of the inner surface of the rack cavity 68 is substantially aligned with the outer surface of the rack 16. The outer surface of the rack 16, therefore, can be in direct, or near direct, engagement with the edge 82 of the rack cavity 68.

Illustrated in FIG. 4 is a side elevation view of the rack portion 52 shown in FIG. 3. FIG. 4 is illustrated as viewing the rack portion 52 along the rack axis 39. The rack yoke housing 80, described above, can be seen in this view of the rack portion 52. Indicated generally at 60 is the stepped flange portion of the rack portion 52. As can be seen on the stepped flange portion 60, the rack cavity 68 is widened to the left side. Therefore, the second core member 122 would have been withdrawn along a line that is angled to the left of the rack axis 39. Also shown in FIG. 4 is a mounting portion 84 that facilitates the attachment of the rack and pinion assembly 50 to the vehicle.

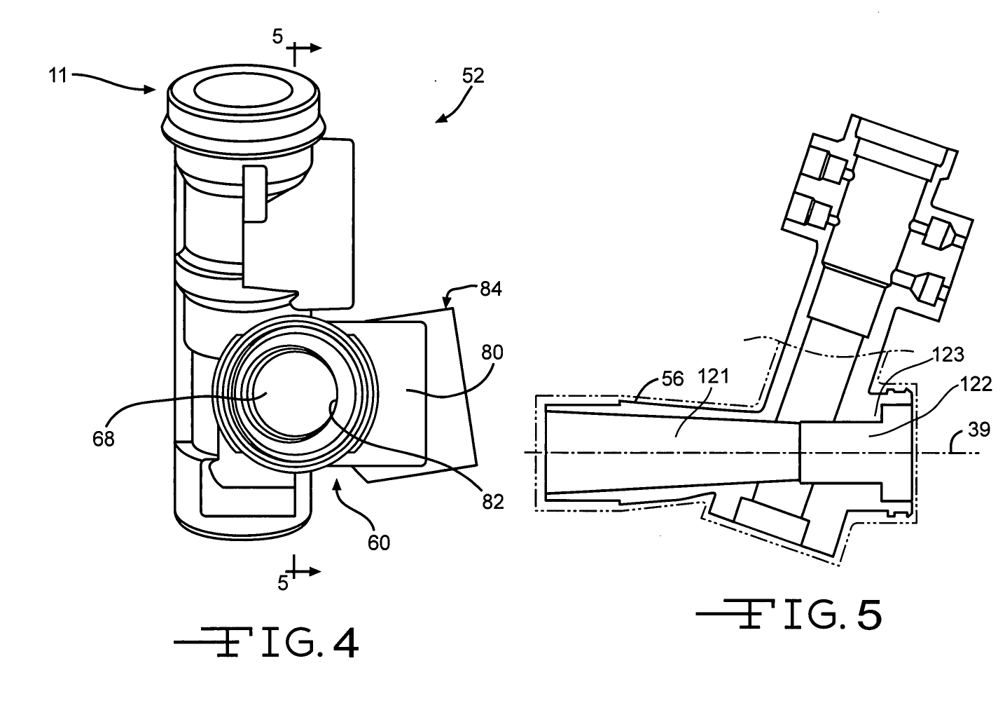

Illustrated in FIG. 5, there is shown a simplified internal view of the rack portion 52 shown in FIG. 4. Also shown in FIG. 5 is the internal structure of the rack tube 56 as well the two core members 121 and 122 positioned therein. As described above, the housing 55 is formed as a cast member. Although two separate core members 121, 122 are shown, it should be appreciated that the rack portion 52 of the housing 55 could be formed be a single core member if it were so desired. In FIG. 5, the rack and pinion steering assembly shown in FIG. 3 is illustrated without the other internal components of the valve assembly 11 and the rack 16. It should be appreciated that the valve portion 58 of the housing 55 can be formed in any suitable manner.

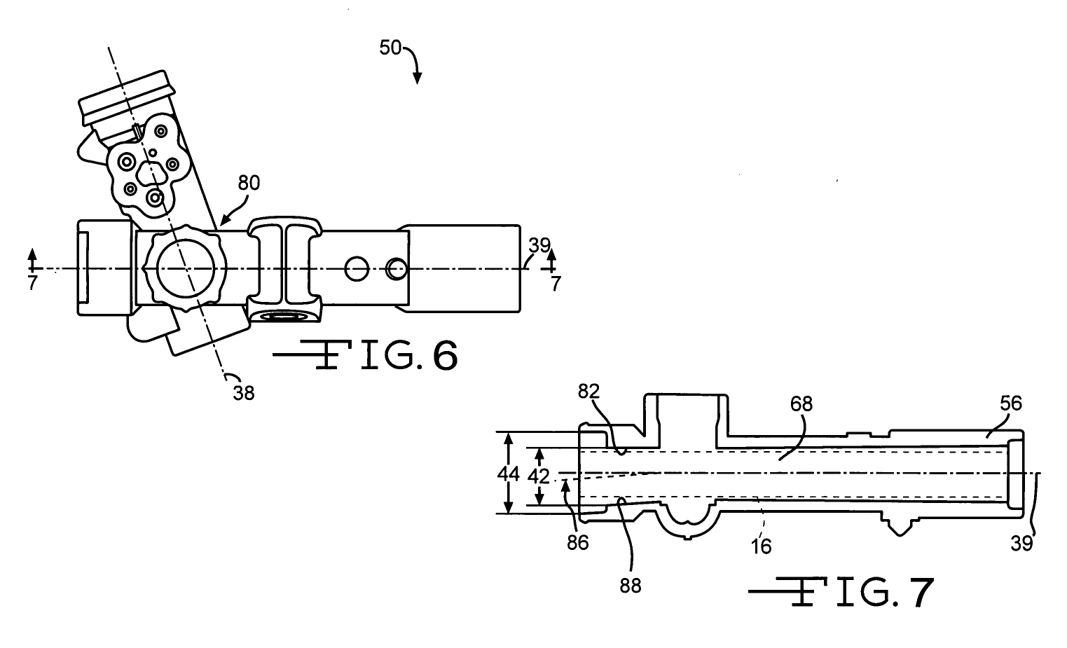

Illustrated in FIG. 6, there is shown an external rear view of the rack and pinion steering assembly 50 of FIG. 3. In this view, the rack yoke housing 80 can be seen. Being an external view, none of the internal components that were shown and described above are shown. Illustrated in FIG. 7, is a simplified internal view of the rack and pinion steering assembly 50 as seen in FIG. 6 through Line 7-7. Therefore, the view of the assembly 50 in FIG. 7 is from underneath the assembly 50. According to the present invention, the casting core member 122 would be withdrawn from a mold cavity at an angle to the rack axis 39. The core withdrawal axis 86 is preferably angled about 1 to 2 degrees from the rack axis 39. Since the casting core member 122 is only withdrawn off angle to one side of the rack cavity 68, a portion of the inner edge surface 82 of the rack cavity 68 is substantially parallel to the rack axis 39. As can also be seen, a portion of the inner surface 88 is angled relative to the rack axis 39 due to the angled withdrawal axis 86 of the core member 122. Since the core member 122 is withdrawn at an angle, the second cylinder 44 will be wider than if the core member 122 were withdrawn along the rack axis 39. Therefore, the second cylinder 44 has an offset centerline relative to the rack axis 39. The first cylinder 42 is coaxial with the rack axis 39. However, as shown in FIG. 7, the leftmost portion 81 of the first cylinder 42 has a surface 88 that is angled relative to the rack axis 39. Illustrated in phantom is a rack 16 to show the general positioning of the rack 16 within the rack cavity 68 relative to the rack portion 52.

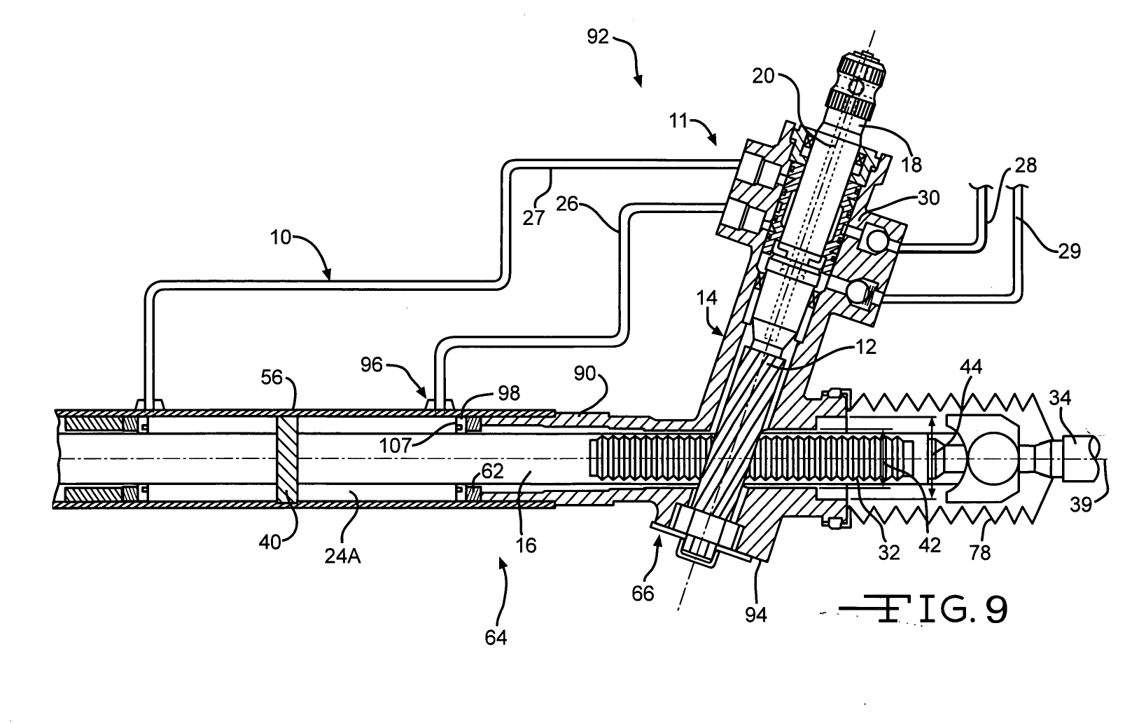

Illustrated in FIG. 3, there was shown and described a first seal mechanism 61. Illustrated in FIGS. 8-12, there are shown alternate embodiments of rack portions and sealing arrangements for rack and pinion steering assemblies according to the present invention. Illustrated in FIG. 8, there is shown a rack and pinion steering assembly 83 that is substantially similar to that shown in FIG. 3. However, in this embodiment, the first cylinder 42 and second cylinder 44 of a stepped flange portion 85 on the right side of the rack portion 87 are substantially coaxial with the rack axis 39. Therefore, although the two cylinders 42 and 44 are concentric, the right side of the rack portion 87 is substantially similar to the rack portion 52 shown in FIG. 3 in that the rack portion 87 has a tapered neck portion 54.

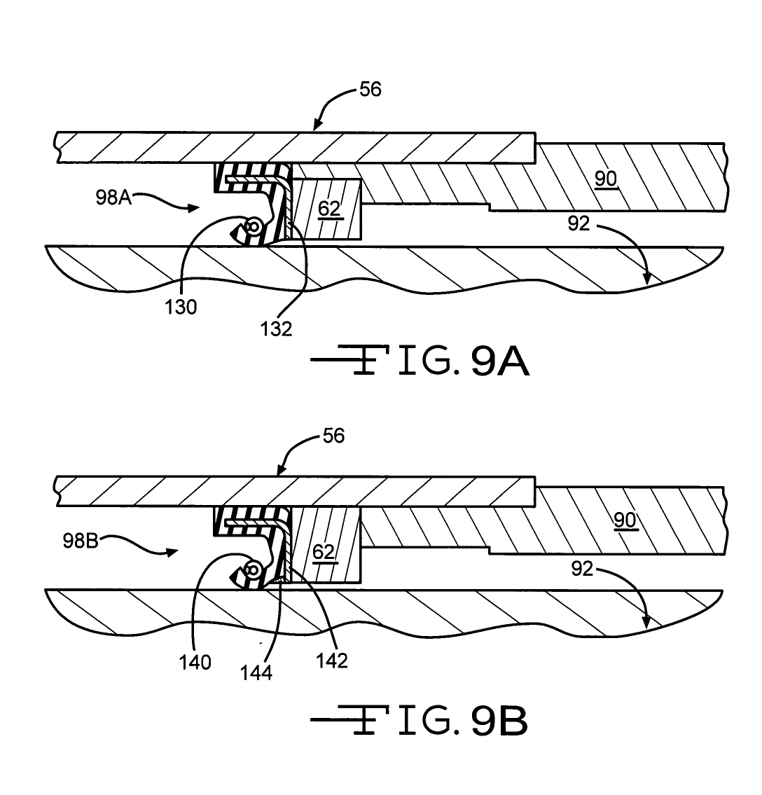

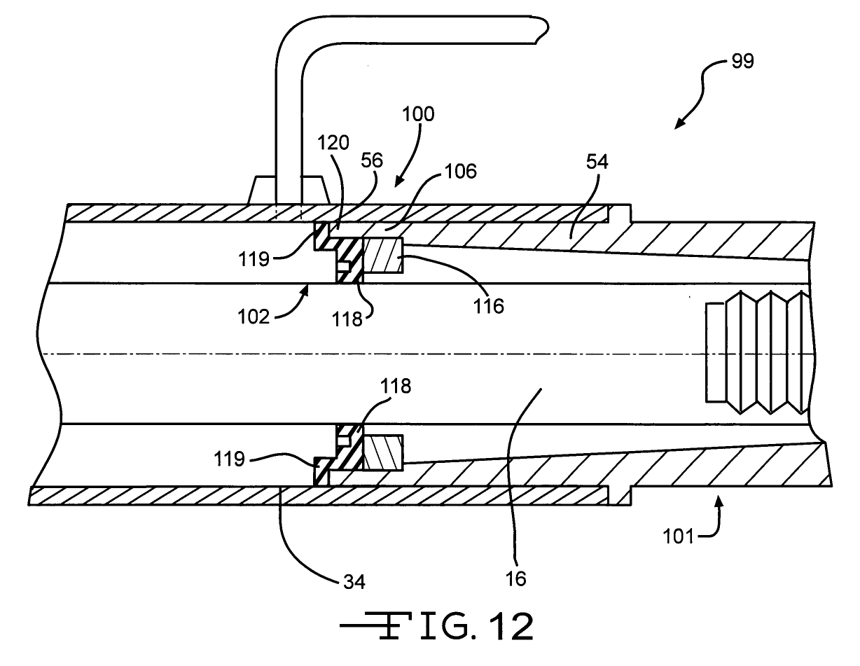

In FIG. 9, the rack and pinion steering assembly 92 includes some of the components that are the same as those shown in FIG. 3. In FIG. 9, instead of the tapered neck portion 54, a stepped neck portion 90 is used. The effect, however, is similar in that there is an increasing inner diameter from the pinion end 66 of the rack portion 94 to the rack tube end 64 of the rack portion 94. Also shown in FIG. 9, a second seal mechanism 96 is shown. The second seal mechanism 96 includes a floating seal 98 that is positioned adjacent the support member 62. The floating seal 98 is preferably made from a suitable elastomeric material and includes a spring member 107 positioned therein. It can be appreciated that the second seal mechanism 96 can be formed without the spring member 107. In such an embodiment, an annular cavity would remain in the floating seal 98 portion of the second seal mechanism 96. The floating seal 98 encircles the rack 16 and abuts, and is preferably connected to, the support member 62. The floating seal 98 seals the inner diameter of the rack tube 54 and seals the outer diameter of the rack 16 but allows axial movement of the rack 16. Since the seal 98 is a floating seal, it eliminates the need for an o-ring 110 needed in the pocket seal embodiment shown and discussed below in connection with FIG. 11. The second seal mechanism 96 is configured to prevent fluid from the rack chamber 24 from passing beyond the limits of the first rack chamber 24A. Additionally, as shown and described above with respect to FIGS. 3, 4, and 7, the first and second cylinders 42, 44, and similar to those shown in FIG. 3, are offset from each other.

Illustrated in FIG. 9A, there is shown an alternate mounting of the support ring 62. As shown in this embodiment, the stepped neck portion 90 includes a pocket or annular recess 90A formed therein for receiving the support ring 62. Preferably, the pocket 90A is formed by a machining process. Also, as shown in this embodiment, a floating seal 98A is provided and is preferably formed from an elastomeric material and can include a garter spring 130 and a case 133.

Illustrated in FIG. 9B, there is shown an alternate construction of a floating seal 98B. As shown in this embodiment, the floating seal 98B is preferably formed from an elastomeric material and can include a garter spring 140, a case 142 and an “anti-extrusion” ring 144.

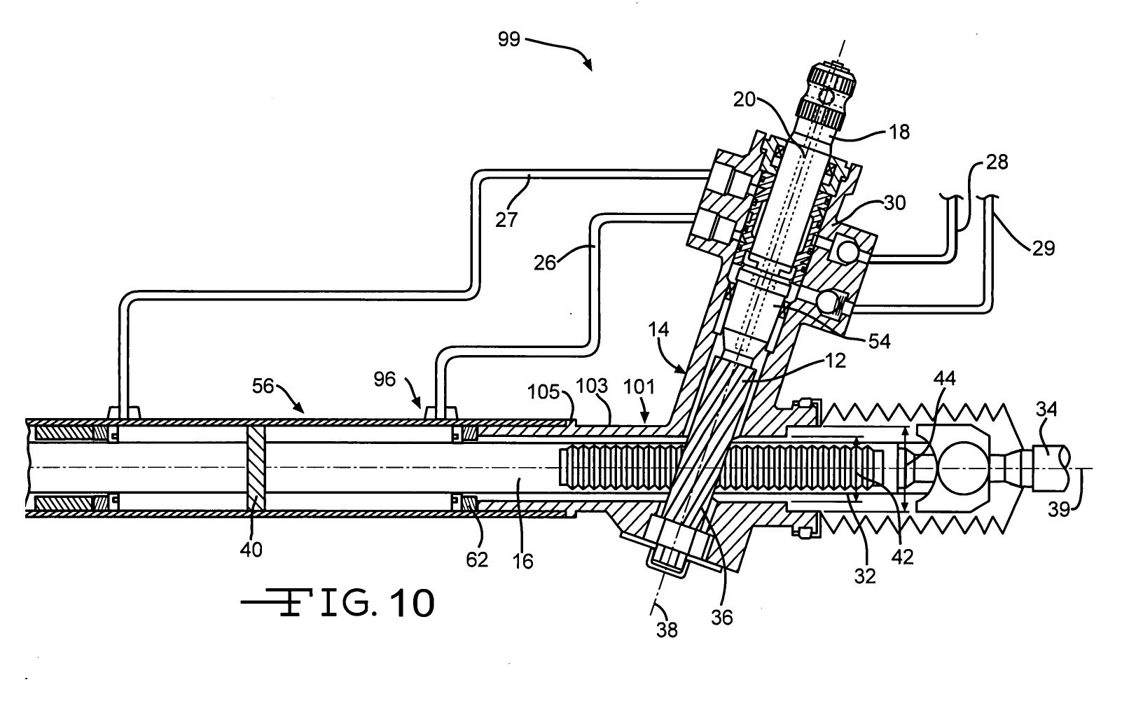

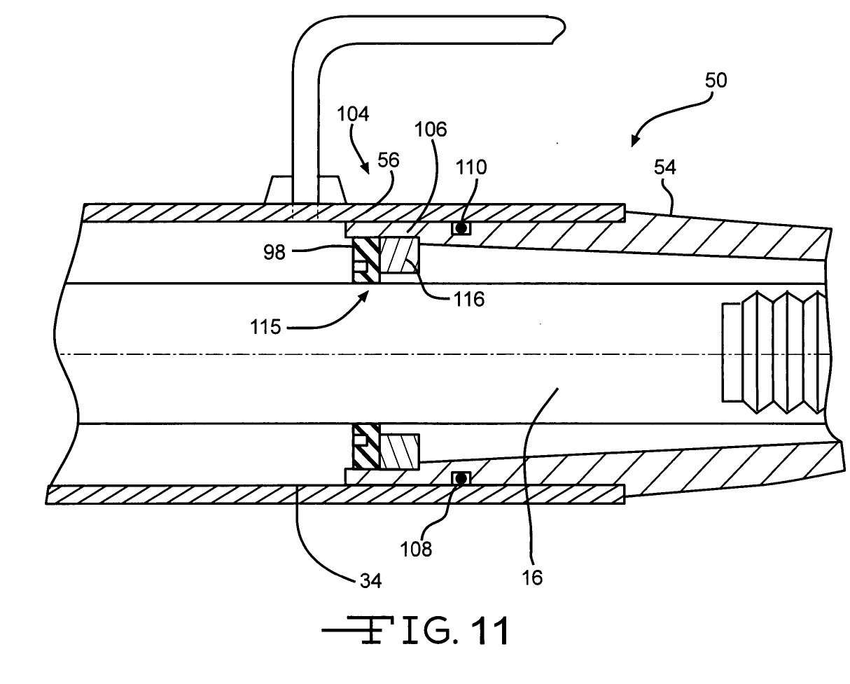

Illustrated in FIG. 10, there is shown a rack and pinion steering assembly 112 that is similar to the rack and pinion steering assembly shown in FIG. 1. Therefore, the rack tube 56 and the neck portion of the rack portion have substantially constant inner diameters versus the tapered neck portion shown in FIG. 3. However, the second seal mechanism 96 is used with this embodiment. The second seal mechanism 96 is substantially similar to that which was shown and described above in FIG. 9. Additionally, as shown and described above with respect to FIGS. 3, 4 and 7, the first and second cylinders 42 and 44, and similar to those shown in FIG. 3, are offset from each other.

Illustrated in FIG. 11, there is shown an enlarged portion of the rack and pinion steering assembly 50 illustrated in FIG. 3. Particularly, that which is shown is the seal mechanism portion of the assembly. However, in this embodiment, a fourth seal mechanism 104 is used. As a part of the fourth seal mechanism 104, a pocketed seal mechanism 115 is used. The pocketed seal mechanism 115 includes a recess 108 and a sealing member 110, such as an O-ring. The recess 108 is formed on the outer surface of the tapered neck portion 54 such that when the rack tube 56 is joined with the tapered neck portion 54, a pocket is formed between the outer surface of the neck portion 54 and the inner surface of the rack tube 56. The O-ring 110 is preferably positioned within the recess 108 thereby creating a seal between the tapered neck portion 54 and the rack tube 56. The O-ring 110 provides an additional back-up sealing surface to prevent fluid from within the rack chamber 24 from passing beyond the fourth seal mechanism 104 and leaking outside the rack and pinion steering assembly 50. In addition, the inner surface of the neck portion 54 can include a step 106. The step 106 is positioned against the side of the support member 116 and extends between the support member 116 and the rack tube 56. The step 106 provides additional lateral support to the support member 116. The step 106 can also be used for positioning the support member 116 relative to the tapered neck portion 54 and the rack tube 56, providing support between those components, or using the step 106 to provide an additional surface for attaching the rack tube 56 and the neck portion 54. Positioned against the support member 116 is a ring 98 that is substantially similar in structure and operation to the ring 98 shown in FIG. 9. However, in this embodiment, the step 106 also supports the ring 98 between the step 106 and the rack 16.

Illustrated in FIG. 12, there is shown a rack and pinion steering assembly 99 that is similar to the rack and pinion steering assembly shown in FIG. 3. However, an alternate seal mechanism is included in this embodiment. In this embodiment, as was described above with respect to FIG. 3, the rack portion 101 has a tapered neck portion 54 that is connected to the rack tube 56. As shown and described in FIG. 11, the end of the tapered neck portion 54 includes a step 106. The step 106 is positioned against the side of the support member 116 and extends between the support member 116 and the rack tube 56. The step 106 provides additional lateral support to the support member 116. The step 106 can also be used for positioning the support member 116 relative to the tapered neck portion 54 and the rack tube 56, providing support between those components, or using the step 106 to provide an additional surface for attaching the rack tube 56 and the neck portion 54. Positioned against the support member 116 is a stepped seal member 102 that is substantially similar in structure and operation to the ring 98 shown in FIG. 9. However, in this embodiment, the step 106 also supports the seal member 102 between the step 106 and the rack 16. Positioned against the support member 116 is the seal member 102 that acts as a sealing ring. The seal member 102 includes a body portion 118 and a lip portion 119. The body portion 118 is substantially similar to the ring 98 shown and described in FIG. 11. However, extending from the body portion 118 is the additional lip portion 119 which further seals the edge 120 of the tapered neck portion 54 and the rack tube 56. The lip 119 can also assist the positioning of the ring 102 against the support member 116, the tapered neck portion 54, and the rack tube 56. The stepped seal member 102 eliminates the O-ring 110 needed in the pocket seal embodiment discussed above in connection with FIG. 11.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A rack and pinion steering assembly comprising:
a housing having a rack portion;
a rack disposed in the rack portion, the rack defining a rack axis; and
a support member configured to limit movement of the rack in a radial direction within the rack portion;
wherein the rack portion includes a tapered neck portion, the tapered neck portion increasing in diameter from an inboard end to an outboard end.

2. The rack and pinion steering assembly defined in claim 1 wherein the tapered neck portion is substantially concentric with the rack axis.

3. The rack and pinion steering assembly defined in claim 2 including a rack tube connected in an overlapping manner to the outboard end of the tapered neck portion, wherein a sealing ring is positioned adjacent the support member at the outboard end of the tapered neck portion of the housing for sealing an area between the rack tube and the rack.

4. The rack and pinion steering assembly defined in claim 2 including a rack tube connected in an overlapping manner to the outboard end of the tapered neck portion, wherein a floating seal ring is positioned adjacent the support member at the outboard end of the tapered neck portion of the housing for sealing an area between the rack and the support member.

5. The rack and pinion steering assembly defined in claim 2 including a rack tube connected in an overlapping manner to the outboard end of the tapered neck portion, wherein a pocketed seal ring is positioned in a pocket formed between the tapered neck portion and the rack tube for sealing an area therebetween.

6. The rack and pinion steering assembly defined in claim 2 including a rack tube connected in an overlapping manner to the outboard end of the tapered neck portion, wherein a sealing ring having a body portion and a lip portion is positioned adjacent the support member and the outboard end of the tapered neck portion of the housing for sealing an area between the rack tube, the rack, and the tapered neck portion.

7. The rack and pinion steering assembly defined in claim 1 wherein the tapered neck portion has a stepped profile.

8. The rack and pinion steering assembly defined in claim 1 wherein the tapered neck portion has a frustoconical profile.

9. The rack and pinion steering assembly defined in claim 1 wherein the rack portion includes a first rack portion which defines a first rack portion axis and a second rack portion axis which is offset relative to the first rack portion axis;
wherein the first rack portion axis is generally coaxial to the rack axis and the second rack portion axis is offset relative to the rack axis.

10. A rack and pinion steering assembly comprising:
a housing having a rack portion, the rack portion including a first rack portion which defines a first rack portion axis and a second rack portion axis which is offset relative to the first rack portion axis; and
a rack disposed in the rack portion, the rack defining a rack axis;
wherein the first rack portion axis is generally coaxial to the rack axis and the second rack portion axis is offset relative to the rack axis.

11. The rack and pinion steering assembly defined in claim 10 wherein the second rack portion axis is offset relative to the rack axis at an angle of approximately 1 to 2 degrees.

12. The rack and pinion steering assembly defined in claim 10 wherein the second rack portion axis is offset from the first rack portion axis such that an outer surface of the rack is substantially aligned with an inner surface of the second rack portion.

13. The rack and pinion steering assembly defined in claim 12 wherein the outer surface of the rack is in contact with the inner surface of the second rack portion.

14. The rack and pinion steering assembly defined in claim 10 wherein the housing comprises a tapered neck portion wherein the neck portion is located opposite the first rack portion and the second rack portion.

15. The rack and pinion steering assembly defined in claim 14 wherein the tapered neck portion increases in diameter from an inboard end of the neck portion to an outboard end of the neck portion.

16. The rack and pinion steering assembly defined in claim 15 including a support member for limiting radial movement of the rack within the rack tube and the rack portion.

17. A method for forming a rack portion of a rack and pinion steering assembly comprising:
providing a first core member;
providing a second core member;
providing an outer mold member defining a casting cavity;
positioning a portion of the first core member into the casting cavity along a rack axis;
positioning a portion of the second core member into the casting cavity in abutting arrangement with the first core member along the rack axis;
introducing a mold material into the casting cavity;
retracting the first core member from the casting cavity along the rack axis;
retracting the second core member from the casting cavity along a second axis wherein the second axis is not parallel to the rack axis.
